(19) United States
(12) Patent Application Publication
(10) Pub. No.: US 2013/0208086 A1
(43) Pub. Date: Aug. 15, 2013

(54) 3D VIDEO REPRODUCTION DEVICE

(71) Applicants: Tadayoshi OKUDA, Osaka (JP); Takuya Sugita, Osaka (JP)

(72) Inventors: Tadayoshi OKUDA, Osaka (JP); Takuya Sugita, Osaka (JP)

(73) Assignee: Panasonic Corporation, Osaka (JP)

(21) Appl. No.: 13/485,934

(22) Filed: Jun. 1, 2012

(30) Foreign Application Priority Data
Feb. 9, 2012 (JP) 2012-026242

(51) Int. Cl. H04N 13/00

(52) U.S. Cl. 348/43; 348/E13.067

(57) ABSTRACT

A 3D video reproduction device configured to reproduce 3D streaming data that includes 3D video data and audio data. The 3D video reproduction device comprises an audio analyzing unit, a parallax setting unit, a video correction unit, and an output unit. The audio analyzing unit is configured to analyze the audio data to determine the scene indicated by the 3D video data. The parallax setting unit is configured to set the amount of parallax that corresponds to the scene based on the audio data analyzed by the audio analyzing unit. The video correction unit is configured to correct the 3D video data based on the amount of parallax set by the parallax setting unit. The output unit is configured to reproduce the corrected 3D video data and output the audio data.

### CROSS-REFERENCE TO RELATED APPLICATIONS

This application claims priority under 35 U.S.C. §119 to Japanese Patent Application No. 2012-026242, filed on Feb. 9, 2012. The entire disclosure of Japanese Patent Application No. 2012-026242 is hereby incorporated herein by reference.

### BACKGROUND

1. Technical Field

The technology disclosed herein relates to a 3D video reproduction device.

2. Background Information

Devices for displaying 3D video have been under development in recent years. Typical 3D video devices can produce a video having parallax capable of being projected onto a screen. The images projected onto the screen (right-eye image and left-eye image) are combined by the viewer's brain and recognized as a three-dimensional image. Also, during projection of the video onto the screen, the user is given a surround effect by emitting acoustic signals from a plurality of speakers (see Japanese Laid-Open Patent Application 2000-122590).

Conventional 3D video devices, such as the one disclosed in Japanese Laid-Open Patent Application 2000-122590, provides the user with three-dimensional video and accompanying surround sound. However, a common characteristic with these conventional 3D video devices is that the surround sound is oversimplified and does not or cannot adequately express the full effects of a three-dimensional video.

### SUMMARY

The technology disclosed herein was conceived in an effort to solve the above problem. Accordingly, one object of the present technology is to provide a 3D video reproduction device in which the effects of a three-dimensional video can be fully expressed.

In accordance with one aspect of the technology disclosed herein, a 3D video reproduction device is provided that reproduces 3D streaming data that includes 3D video data and audio data. The 3D video reproduction device comprises an audio analyzing unit, a parallax setting unit, a video correction unit, and an output unit. The audio analyzing unit is configured to analyze the audio data to determine the scene indicated by the 3D video data. The parallax setting unit is configured to set the amount of parallax that corresponds to the scene based on the audio data analyzed by the audio analyzing unit. The video correction unit is configured to correct the 3D video data based on the amount of parallax set by the parallax setting unit. The output unit is configured to reproduce the corrected 3D video data and output the audio data.

With this 3D video reproduction device, the scene indicated by 3D video data can be determined by analyzing the audio data. Also, the 3D video data is corrected, and the corrected 3D video data is reproduced, by setting the amount of parallax that corresponds to the scene of the video based on this analysis result. Thus, this 3D video reproduction device expresses 3D video by using 3D video data and audio data in concert with each other. Consequently, this 3D video reproduction device can more fully express the effect of 3D video than in a conventional scenario in which 3D video data and audio data are simply used as independent data and outputted to an output unit.

The 3D video reproduction device of the present technology can fully express the effects of three-dimensional video.

These and other objects, features, aspects and advantages of the present invention will become apparent to those skilled in the art from the following detailed description, which, taken in conjunction with the annexed drawings, disclose embodiments of the present invention.

### BRIEF DESCRIPTION OF THE DRAWINGS

Referring now to the attached drawings, which form a part of this original disclosure:

FIG. 1 is a diagram of the overall configuration of a 3D video reproduction device;

FIG. 2A shows the state when video is viewed by a user (video reference state);

FIG. 2B shows the state when video is viewed by a user (video close-up state);

FIG. 2C shows the state when video is viewed by a user (video distant state);

FIG. 3A is a concept diagram of the amount of parallax used to add a 3D effects to video (video close-up state);

FIG. 3B is a concept diagram of the amount of parallax used to add a 3D effects to video (video distant state);

FIG. 4 is a graph of the corresponding relation between volume data for a correction channel and amplification coefficients (first amplification coefficient, second amplification coefficient);

FIG. 5 is a graph of the corresponding relation between the amount of amplification due to volume and a third amplification coefficient;

FIG. 6 is a flowchart of video correction processing and scene decision processing based on audio;

FIG. 7A shows the state when video is viewed by a user in another embodiment (part 1);

FIG. 7B is a concept diagram of the amount of parallax in another embodiment (part 1);

FIG. 8A shows the state when video is viewed by a user in another embodiment (part 2); and

FIG. 8B is a concept diagram of the amount of parallax in another embodiment (part 2).

### DETAILED DESCRIPTION OF EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

Configuration of 3D Video Reproduction Device

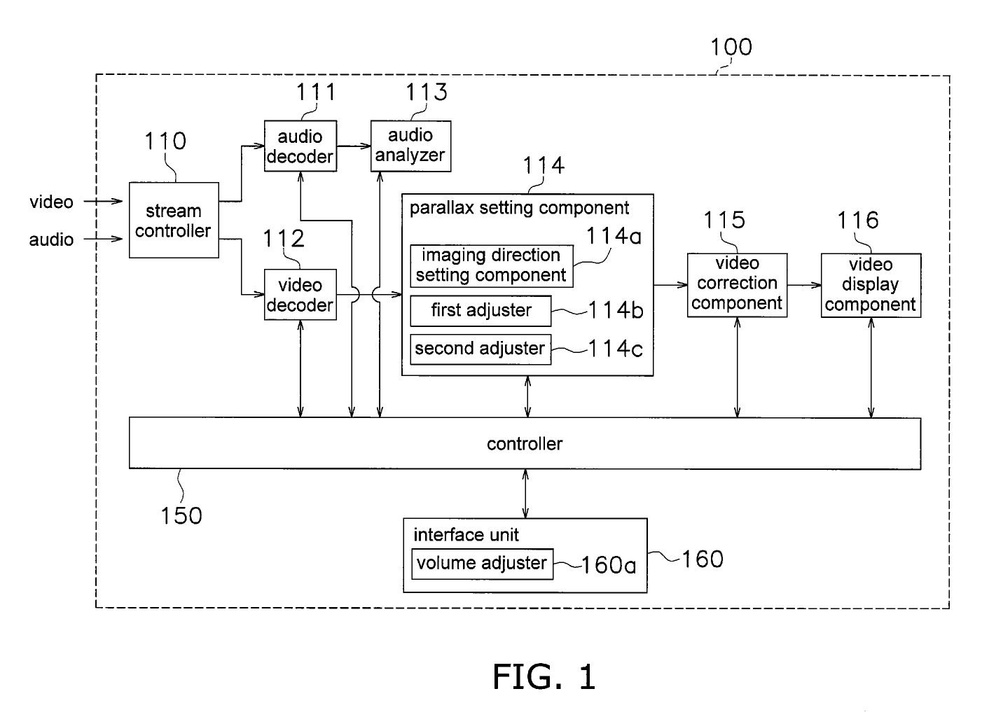

FIG. 1 is a diagram of the overall configuration of a 3D video reproduction device 100. The 3D video reproduction device 100 reproduces 3D streaming data having 3D video data and a plurality of sets of audio data. 3D streaming data (3D video data and a plurality of sets of audio data) is inputted to the 3D video reproduction device 100.

The 3D video reproduction device 100 comprises a control unit 150, an interface unit 160, a stream control unit 110, an audio decode unit 111, a video decode unit 112, an audio analyzing unit 113, a parallax setting unit 114, a video correction unit 115, and a video display unit 116 (one example of an output unit).

The control unit 150 provides overall control of the operation of the entire 3D video reproduction device 100. The control unit 150 is made up of a CPU (central processing unit), a ROM (read-only memory), and so forth. Programs related to basic control and the like are stored in the ROM.

The interface unit 160 handles command inputs from a user. When the interface unit 160 receives a command from the user, it sends the control unit 150 a signal corresponding to the content of the command. A volume adjuster 160a is included in the interface unit 160. When the volume is set with the volume adjuster 160a, a signal corresponding to that volume is sent to the control unit 150.

The stream control unit 110 separates 3D streaming data inputted to the 3D video reproduction device 100 into 3D video data and audio data, and then outputs the 3D video data and audio data separately to the outside. The 3D video data has, for example, left-use video data and right-use video data. For example, the plurality of sets of audio data includes surround audio data for a plurality of channels.

The audio decode unit 111 decodes the audio data for each channel outputted from the stream control unit. The video decode unit 112 decodes 3D video data outputted from the stream control unit 110, such as left and right video data.

The audio analyzing unit 113 analyzes audio data in order to determine the state of each scene indicated by the 3D video data. More precisely, the audio analyzing unit 113 calculates sound pressure data (one example of first characteristic data) indicating the strength of audio and volume data (one example of second characteristic data) indicating the volume of the audio, by analyzing the audio data.

More specifically, audio data is audio time-series data corresponding to video data. The audio analyzing unit 113 calculates sound pressure data and volume data based on this audio time-series data. Sound pressure data is calculated, for example, by using this equation:

Lp(t)=10×log 10(P(t)/Po)².

Here, P(t) is audio data, and Po is a reference sound pressure. The audio data is the audio data P(t) at the point in time t in time-series data.

The audio data to be analyzed in audio time-series data may be the audio data for each channel, corresponding to video at a certain point in time of output to the video display unit 116, or may be the average for audio data for the various channels within a specific range prior to a certain point in time of output to the video display unit 116. This average can be, for example, the average of audio data for each channel which is decoded prior to being outputted to the video display unit 116 and stored in a buffer.

The parallax setting unit 114 sets the amount of parallax that corresponds to each scene displayed in the video, based on the analyzed audio data. Here, the amount of parallax corresponds, for example, to the amount of change in information about the position in the horizontal direction, for a position, region, object, etc., corresponding to a left-eye image and a right-eye image.

The parallax setting unit 114 has an imaging direction setting unit 114a, a first adjust unit 114b (first parallax adjustment unit), and a second adjust unit 114c (second parallax adjustment unit).

The imaging direction setting unit 114a sets the imaging direction corresponding to each scene. The imaging direction corresponding to each scene is set based on the audio data. More specifically, the imaging direction setting unit 114a selects at least one set of audio data from among a plurality of sets based on the sound pressure data for each of the plurality of sets of audio data (sound pressure data for each channel). The imaging direction setting unit 114a then sets the imaging direction to a single direction, with respect to a plane in which the amount of parallax is zero (reference plane) based on the selected audio data. The imaging direction has a receding direction and an approaching direction. The imaging direction setting unit 114a sets the imaging direction to either the receding direction or the approaching direction based on the selected audio data.

The term “receding direction” here refers to the direction in which an object appears to be moving away from the user, using the reference plane as a reference. The “approaching direction” is the direction in which an object appears to be moving toward the user, using the reference plane as a reference.

The first adjust unit 114b adjusts the amount of parallax so that movement of the object is recognized as being toward the set imaging direction. More specifically, the first adjust unit 114b adjusts the amount of parallax so that movement of the object is recognized as being toward the set imaging direction based on volume data for the selected audio data. How the amount of parallax is adjusted will be discussed in detail below.

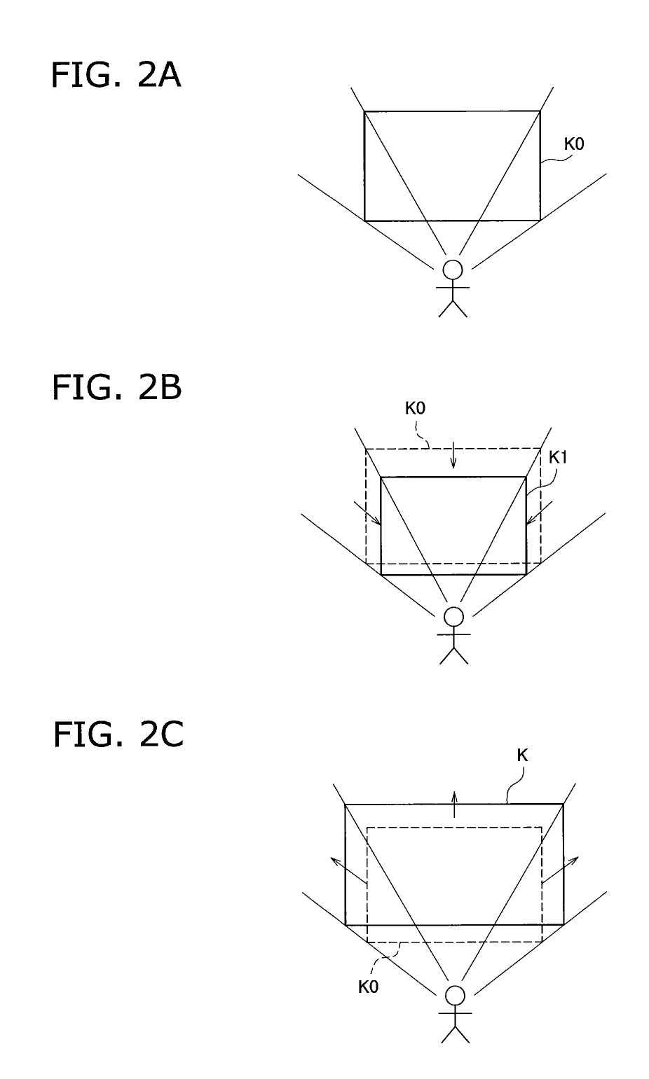

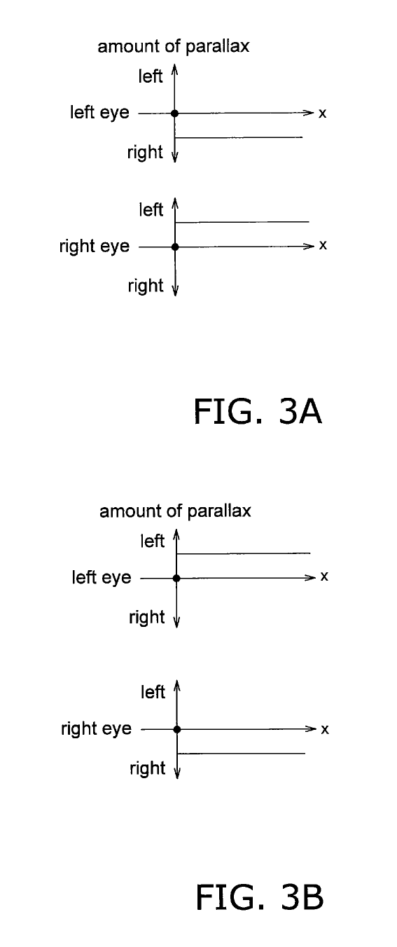

As shown in FIGS. 2B and 2C (discussed below), and in FIGS. 3A and 3B (discussed below), the setting of the imaging direction corresponds to the set direction for the amount of parallax. For example, when the imaging direction is the approaching direction, the set direction for the amount of parallax is set to the direction shown in FIG. 3A. When the imaging direction is the receding direction, the set direction for the amount of parallax is set to the direction shown in FIG. 3B.

The second adjust unit 114c also adjusts the amount of parallax in the imaging direction based on volume data adjusted by the volume adjuster. How the amount of parallax is further adjusted will be discussed in detail below.

The video correction unit 115 corrects 3D video data based on the amount of parallax that corresponds to each scene. The 3D video data (left and right video data) inputted to the 3D video reproduction device 100 already has left and right parallax. However, when the amount of parallax is set as above, the 3D video data is corrected so that the amount of parallax of the 3D video data is the amount set above.

The video display unit 116 reproduces corrected 3D video data and outputs audio data. The video display unit 116 is a liquid crystal monitor equipped with speakers, for example. In this case, the corrected 3D video data is displayed on the liquid crystal monitor, and audio data for the various channels is outputted from the speakers.

The 3D video reproduction device 100 further has a RAM (random access memory) (not shown). This RAM functions as a working memory (buffer memory) for a control unit 130. The RAM is a volatile storage medium, such as a DRAM (dynamic random access memory).

Operation of 3D Video Reproduction Device

The operation of the 3D video reproduction device 100 will now be described through reference to FIGS. 2 to 5. First, FIGS. 2 to 5 themselves will be described.

FIGS. 2A to 2C show the state when video is viewed by a user. FIG. 2A is an example of when there is no 3D effects produced in the 3D video. FIG. 2B is an example of when a 3D effects occurs on the user side. FIG. 2C is an example of when a 3D effects occurs in the direction of moving away from the user.

FIGS. 3A and 3B are concept diagrams of the amount of parallax used to add a 3D effects to video. FIG. 3A corresponds to FIG. 2B. In FIG. 3A, a specific amount of parallax is added on the right side to the left-eye video data, using the position where the amount of parallax is zero as a reference. A specific amount of parallax is added on the left side to the right-eye video data, using the position where the amount of parallax is zero as a reference.

FIG. 3B corresponds to FIG. 2C. In FIG. 3B, a specific amount of parallax is added on the left side to the left-eye video data, using the position where the amount of parallax is zero as a reference. A specific amount of parallax is added on the right side to the right-eye video data, using the position where the amount of parallax is zero as a reference.

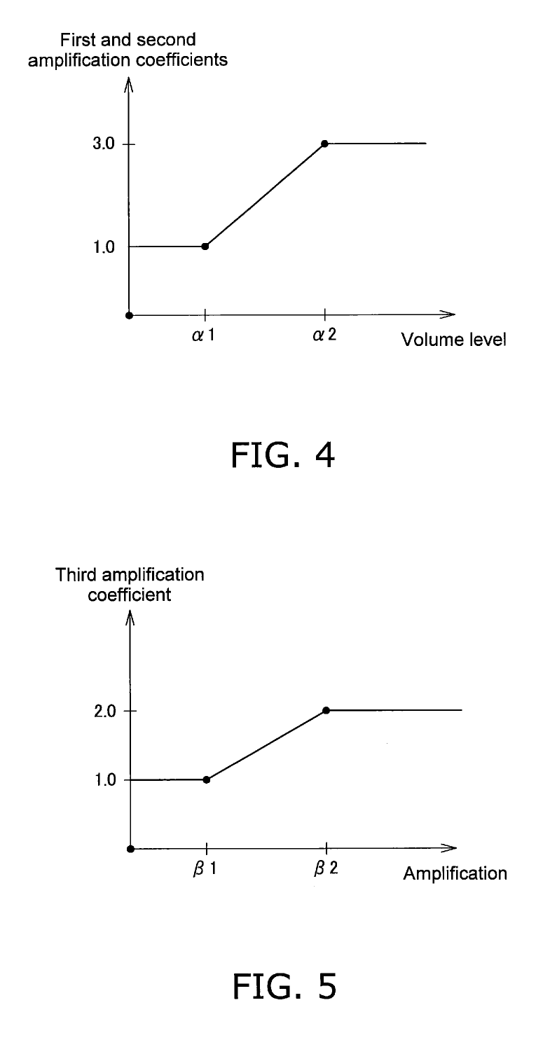

FIG. 4 is a graph of the corresponding relation between volume data for a correction channel and amplification coefficients (first amplification coefficient, second amplification coefficient). In FIG. 4, the setting is such that the amplification coefficients increase linearly within a range of not less than a specific first volume level α1 and not more than a specific second volume level α2. At less than the specific first volume level α1, the amplification coefficients are constant at 1.0, and within a range that is greater than the specific second volume level α2, the amplification coefficients are constant at 3.0.

FIG. 5 is a graph of the corresponding relation between the amount of amplification due to volume and a third amplification coefficient. In FIG. 5, the setting is such that the third amplification coefficients increase linearly within a range of not less than a specific first amplification amount β1 and not more than a specific second amplification amount β2. At less than the specific first amplification amount β1, the amplification coefficients are constant at 1.0, and within a range that is greater than the specific second amplification amount β2, the amplification coefficients are constant at 2.0.

FIGS. 4 and 5 show examples of when the amplification coefficients increase linearly, but the amplification coefficients may be varied by any method. For example, the amplification coefficients may be increased in stages, or may be increased using a polynomial curve. Also, in FIG. 4, the first amplification coefficient and the second amplification coefficient were described using the same graph, but the first amplification coefficient and the second amplification coefficient may use different lines and/or curves.

Also, the specific first volume level α1 and specific second volume level α2 in FIG. 4, and the specific first amplification amount β1 and specific second amplification amount β2 in FIG. 5 can be changed to other values as desired. Also, the upper and lower limit values for the amplification coefficients in FIGS. 4 and 5 can be changed to other values as desired.

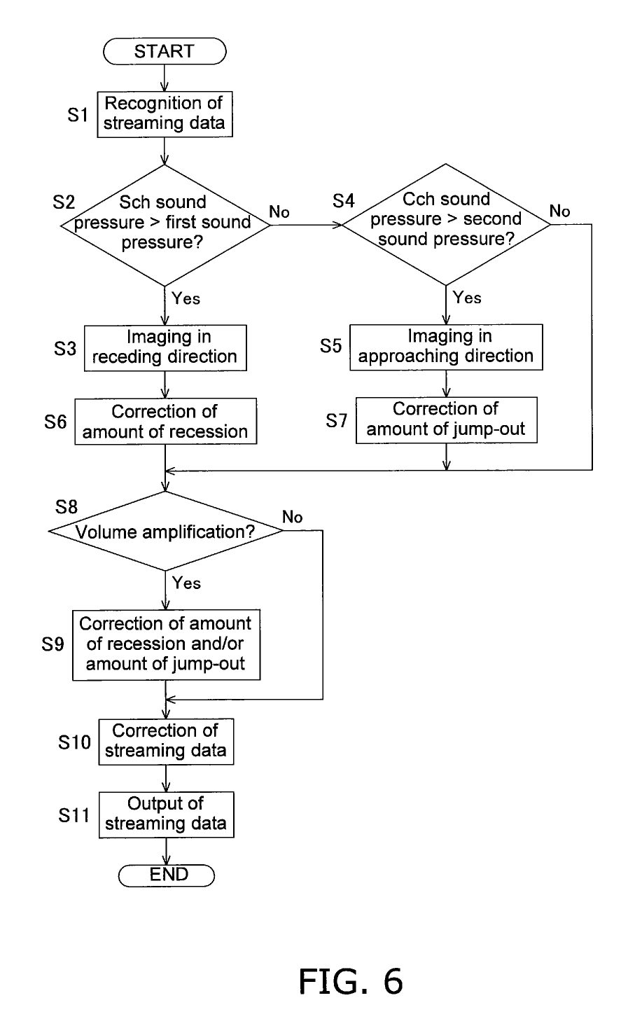

The processing performed by the 3D video reproduction device 100 will now be described through reference to FIGS. 2 to 5 and by following along with the flowchart in FIG. 6. An example will be described here of a case in which audio data included in 3D streaming data is 5.1-channel surround audio data. In this case, the audio data for the center channel includes audio data for people, etc., for example. The audio data for the channels other than the center channel (five surround channels) includes audio data for environmental sound (such as for the landscape within the screen).

In the following embodiment, audio data for human dialog etc., and/or audio data for environmental sound (such as for the landscape within the screen) etc., was used as an example to facilitate the description, but this audio data may be any kind at all.

With this 3D video reproduction device 100, when the control unit 130 recognizes 3D streaming data that includes 3D video data and audio data (S1), the direction (imaging direction) of setting an object K1 (viewing screen) is set with respect to a plane K0 (reference plane) at which the amount of parallax is zero based on the sound pressure data for each channel (see FIGS. 2A to 2C).

More precisely, it is determined whether or not audio data for all the channels other than the center channel (surround channels) is greater than a specific first sound pressure data (S2). For example, first the surround channel having the greatest sound pressure data (first correction-use channel) is selected from among the five surround channels. Next, if the sound pressure data for this first correction-use channel is greater than the specific first sound pressure data (Yes in S2), the imaging direction is set to the direction in which the viewing screen K1 is moving away from the user (receding direction), using the reference plane K0 as a reference (S3). In this case, the user recognizes the viewing screen K1, for example a landscape within the screen, at a position that is away from the user. Consequently, the landscape within the screen, etc., appears more dynamic to the user.

An example was given here of a case of setting the imaging direction to the receding direction when the greatest sound pressure data of the five surround channels was greater than the specific first sound pressure data, but the imaging direction may be set to the receding direction when the average sound pressure data of the five surround channels is greater than the specific first sound pressure data. In this case, the average sound pressure data of the five surround channels is set as the first correction-use channel.

Next, if the first correction-use channel is at or under the specific first sound pressure data (No in S2), it is determined whether or not the sound pressure data for the center channel (the second correction-use channel) is greater than a specific second sound pressure data (S4). Here, if the sound pressure data for the second correction-use channel is greater than the specific second sound pressure data (Yes in S4), the imaging direction is set to the direction in which the viewing screen K1 is moving toward the user (approaching direction), using the reference plane K0 as a reference (S5). In this case, the user recognizes that the viewing screen K1, for example a person within the screen, is located close to the user. Consequently, the user pays more attention to the person or the like within the screen.

If the sound pressure data for the second correction-use channel (center channel) is at or under the specific second sound pressure data (No in S4), the setting of the imaging direction is not executed, and the processing in step 8 (S8; discussed below) is executed.

Next, when the imaging direction is set as above, the amount by which the viewing screen K1 jumps out or recedes is corrected based on the volume data for each channel.

More specifically, if the imaging direction is set to the receding direction (S3), the amount by which the viewing screen K1 recedes is corrected based on the volume data for the first correction-use channel (S4). Even more specifically, in this case the amount of recession is corrected so that the greater is the volume data for the first correction-use channel, the more the viewing screen K1 jumps out (S6).

Here, the amount of recession of the viewing screen K1 is corrected by multiplying the first amplification coefficient shown in FIG. 4 by a parallax amount. The first amplification coefficient is a coefficient corresponding to the volume data for the first correction-use channel. Thus the amount of recession of the viewing screen K1 is corrected by correcting the parallax. For example, the corresponding relation between the first amplification coefficient and the volume data for the first correction-use channel is set as shown in FIG. 4. A table giving this corresponding relation is recorded to the ROM of the control unit 150, and the first amplification coefficient is calculated by referring to this table.

Meanwhile, if the imaging direction is set to the approaching direction, the amount by which the viewing screen K1 jumps out is corrected according to the volume data for the second correction-use channel (center channel) (S7). More specifically, in this case amount of jump-out is corrected so that the greater is the volume data for the second correction-use channel, the greater is the amount by which the viewing screen K1 jumps out.

Here, the amount by which the viewing screen K1 jumps out is set by multiplying the second amplification coefficient shown in FIG. 4 by the amount of parallax. Thus the amount by which the viewing screen K1 jumps out is corrected by correcting the amount of parallax. For example, the corresponding relation between the second amplification coefficient and the volume data for the second correction-use channel is set as shown in FIG. 4. A table giving this corresponding relation is recorded to the ROM of the control unit 150, and the second amplification coefficient is calculated by referring to this table.

Next, it is determined whether or not amplification by volume has been performed (S8). If volume amplification has been performed (Yes in S8), then the amount by which the viewing screen K1 recedes and/or the amount by which the viewing screen K1 jumps out is further corrected according to the amount of amplification by volume (S9). The amplification amount is the current volume with respect to a preset volume (a reference value).

In this case, the amount by which the viewing screen K1 recedes and/or the amount by which the viewing screen K1 jumps out is further set by multiplying a third amplification coefficient corresponding to the amount of volume amplification by the above-mentioned corrected amount of parallax. If the answer is “No” in S4, the amount by which the viewing screen K1 recedes and/or the amount by which the viewing screen K1 jumps out is set by multiplying the third amplification coefficient corresponding to the amount of volume amplification by the uncorrected amount of parallax. The corresponding relation between the third amplification coefficient and the amount of volume amplification is set as shown in FIG. 5. A table giving this corresponding relation is recorded to the ROM of the control unit 150, and the third amplification coefficient is calculated by referring to this table.

When the left and right amounts of parallax corresponding to each scene are thus set based on the audio data for each channel, the 3D video data is corrected based on these parallax amounts (S10). As a result, the corrected 3D video data is displayed on the liquid crystal monitor, and audio data for the various channels is outputted from the speakers (S 11).

Features of 3D Video Reproduction Device

The 3D video reproduction device 100 of the present technology reproduces 3D streaming data having 3D video data and audio data. This 3D video reproduction device 100 comprises the audio analyzing unit 113, the parallax setting unit 114, the video correction unit 115, and the video display unit 116. The audio analyzing unit 113 analyzes audio data in order to determine the scene indicated by 3D video data. The parallax setting unit 114 sets the amount of parallax that corresponds to the video scene based on the audio data analyzed by the audio analyzing unit 113. The video correction unit 115 corrects 3D video data based on the amount of parallax set by the parallax setting unit 114. The video display unit 116 reproduces corrected 3D video data and outputs audio data.

With this 3D video reproduction device 100, the scene indicated by the 3D video data can be determined by analyzing the audio data for each channel. The 3D video data is corrected, and the corrected 3D video data is reproduced, by setting a parallax amount corresponding to the video scene based on this analysis result. Thus, this 3D video reproduction device expresses 3D video by using 3D video data and audio data in concert with each other. Consequently, this 3D video reproduction device can more fully express the effects of 3D video than in a conventional scenario in which 3D video data and audio data are simply used as independent data and outputted to an output unit.

### Other Embodiments

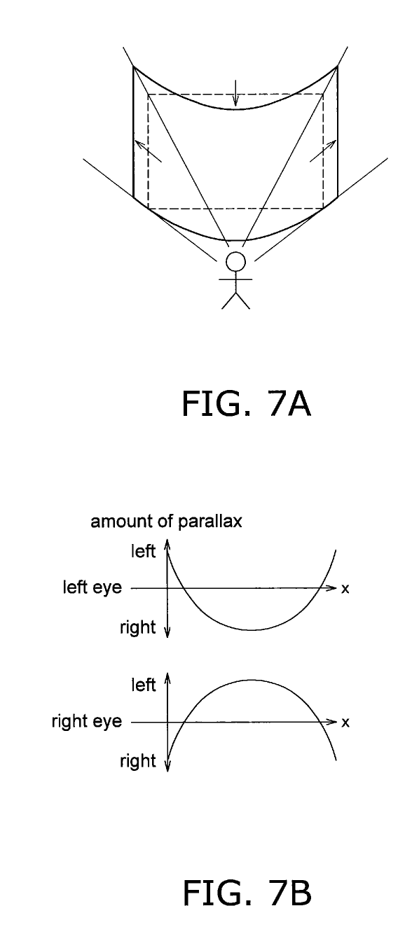

(a) In the above embodiment, an example was given in which the imaging direction was set to the approaching direction when the sound pressure data for the first correction-use channel was at or under a specific first sound pressure data, and the sound pressure data for the second correction-use channel was greater than a specific second sound pressure data. As shown in FIGS. 7A and 7B, however, the imaging direction may instead be set to the receding direction at the left and right ends, and set to the approaching direction in the middle. In this case, the amount of jump-out and the imaging direction at the left and right ends are set using the audio data for the left and right channels of the center channel (the left and right front channels, or the left and right rear channels). Also, the amount of jump-out and the imaging direction of the middle part are set using the audio data for the center channel. This affords the same effects as those discussed above, and allows video that is better optimized spatially to be provided to the user.

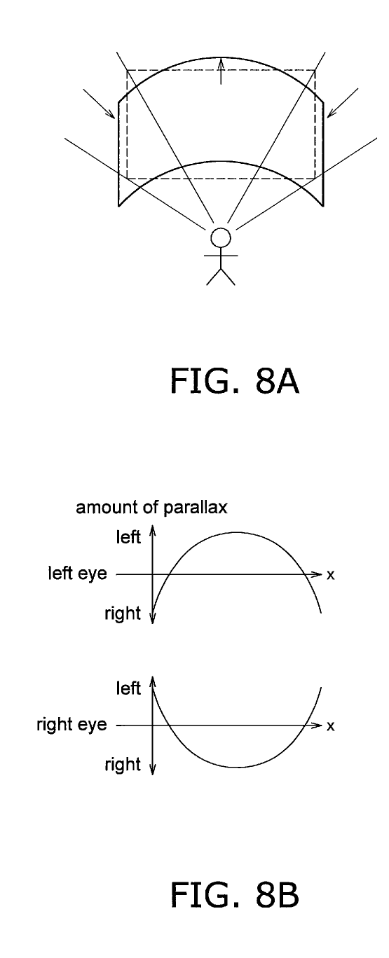

(b) In the above embodiment, an example was given in which the imaging direction was set to the receding direction when the sound pressure data for the first correction-use channel was greater than a specific first sound pressure data, and the sound pressure data for the second correction-use channel was at or under a specific second sound pressure data. As shown in FIGS. 8A and 8B, however, the imaging direction may instead be set to the approaching direction at the left and right ends, and set to the receding direction in the middle. In this case, the amount of jump-out and the imaging direction at the left and right ends are set using the audio data for the left and right channels of the center channel (the left and right front channels, or the left and right rear channels). Also, the amount of jump-out and the imaging direction of the middle part are set using the audio data for the center channel. This affords the same effects as those discussed above, and allows video that is better optimized spatially to be provided to the user.

(c) In the above embodiment, an example was given in which there were 5.1 surround channels, but the number of channels is not limited to what was given in the embodiment above, and any number may be used so long as there are a plurality.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the 3D video reproduction device. Accordingly, these terms, as utilized to describe the present invention should be interpreted relative to the 3D video reproduction device.

The term “configured” as used herein to describe a component, section, or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

### INDUSTRIAL APPLICABILITY

The present technology can be broadly applied to 3D video reproduction devices.

What is claimed is:

1. A 3D video reproduction device configured to reproduce 3D streaming data that includes 3D video data and audio data, the 3D video reproduction device comprising:
an audio analyzing unit configured to analyze the audio data to determine the scene indicated by the 3D video data;
a parallax setting unit configured to set the amount of parallax that corresponds to the scene, based on the audio data analyzed by the audio analyzing unit;
a video correction unit configured to correct the 3D video data based on the amount of parallax set by the parallax setting unit; and
an output unit configured to reproduce the corrected 3D video data and output the audio data.

2. The 3D video reproduction device according to claim 1, wherein
the parallax setting unit includes an imaging direction setting unit and a first parallax adjustment unit, the imaging direction setting unit is configured to set an imaging direction that corresponds to the scene, and the first parallax adjustment unit is configured to adjust the amount of parallax that corresponds to the imaging direction.

3. The 3D video reproduction device according to claim 2, wherein
the audio analyzing unit is configured to calculate first characteristic data and second characteristic data, the first characteristic data indicates the strength of the audio based on the audio data and the second characteristic data indicates the volume of the audio based on the audio data,
the imaging direction setting unit is configured to set the imaging direction based on the first characteristic data, and
the first parallax adjustment unit is configured to adjust the amount of parallax based on the second characteristic data.

4. The 3D video reproduction device according to claim 3, wherein
the 3D streaming data includes a plurality of sets of audio data,
the imaging direction setting unit is configured to select at least one of the plurality of sets of audio data based on the first characteristic data for each of the plurality of sets of audio data, the imaging direction setting unit is further configured to set the imaging direction based on the selected set or sets from the plurality of sets of audio data, and
the first parallax adjustment unit is configured to adjust the amount of parallax set by the parallax setting unit based on the second characteristic data for the selected audio data.

5. The 3D video reproduction device according to claim 2, wherein
the imaging direction setting unit is configured to set the imaging direction to one direction.

6. The 3D video reproduction device according to claim 2, wherein
the imaging direction setting unit is configured to change the imaging direction according to the position of the screen on which the 3D video data is reproduced.

7. The 3D video reproduction device according to claim 2, further comprising:
a volume adjuster configured to adjust sound volume generated by the audio data, wherein
the parallax setting unit includes a second parallax adjustment unit configured to further adjust the amount of parallax of the imaging direction based on the volume adjusted by the volume adjuster.
